(19) United States
(12) Patent Application Publication
(10) Pub. No.: US 2025/0242509 A1
(43) Pub. Date: Jul. 31, 2025

(54) STATIC CUTTER OF HAIR CUTTER AND HAIR CUTTER

(71) Applicants: YUANHAI MEDICAL TECHNOLOGY CO., LTD, Wenzhou, Zhejiang (CN); ZHEJIANG HAISHUN ELECTRIC ENTERPRISES LTD, Wenzhou, Zhejiang (CN)

(72) Inventor: Haiyong SUN, Wenzhou, Zhejiang (CN)

(73) Assignees: YUANHAI MEDICAL TECHNOLOGY CO., LTD, Wenzhou, Zhejiang (CN); ZHEJIANG HAISHUN ELECTRIC ENTERPRISES LTD, Wenzhou, Zhejiang (CN)

(21) Appl. No.: 18/703,331

(22) PCT Filed: Aug. 22, 2022
(86) PCT No.: PCT/CN2022/113840

§ 371 Date: Apr. 20, 2024

(30) Foreign Application Priority Data
Nov. 12, 2021 (CN) 202111346186.2

(51) Int. Cl. B26B 19/06; B26B 19/38

(52) U.S. Cl. CPC B26B 19/06; B26B 19/3846; B26B 19/386

(57) ABSTRACT

A static cutter of a hair cutter and the hair cutter are provided, the static cutter cooperates with a movable cutter to cut hair, the static cutter has at least one static cutter cutting portion, the static cutter has a first surface, facing a skin, and a second surface, opposite to the first surface, and the static cutter has a local recess area, the local recess area is formed in the first surface or the second surface, and the local recess area at least partially overlaps with an area where the static cutter cutting portion is located.

This application claims priority of Chinese Patent Application No. CN202111346186.2, titled “STATIC CUTTER OF HAIR CUTTER AND HAIR CUTTER”, filed with the China National Intellectual Property Administration on Nov. 12, 2021, which is incorporated herein by reference in its entirety.

### FIELD

The present application relates to a static cutter and a hair cutter having the static cutter.

### BACKGROUND

In the patent with application Number of 201520235738.6, a fixed blade and a blade assembly are provided. Specifically, as shown in FIG. 1, the fixed blade, which is arranged to move through the hair in a moving direction to cut hair, includes a first wall portion which is arranged as a wall facing the skin during operation, a second wall portion which deviates from the first wall portion, a guiding groove which is defined between the first wall portion and the second wall portion and is arranged to receive a movable cutting blade, and at least one toothed front edge formed by the first wall portion and the second wall portion. The at least one toothed front edge includes multiple teeth, the first wall portion and the second wall portion are connected at a front end of the at least one toothed front edge to form a tip of the teeth, the fixed blade is an integrally formed metal-plastic composite blade, the first wall portion is at least partially made of metal, and the second wall portion is at least partially made of plastic. In the above patent, in order to ensure the strength of the static blade, the second wall portion is provided for strengthening the strength of the first wall portion. The second wall portion for strengthening is arranged to be partially made of plastic. In such arrangement, although the strength required by a thinner static cutter can be met to a certain extent, the molding process and cost are relatively high. In addition, in order to cut relatively short hairs and achieve good cutting effect, the blade assembly in the prior art need to provide a supporting structure (a fixed blade seat) used in conjunction with the fixed blade for strengthening the strength of the fixed blade, so as to avoid the shaking or jumping of the movable cutter during use due to the bending deformation of the fixed blade in a direction perpendicular to a moving direction of the movable cutter. Generally, a blade assembly is present in the prior art, which is provided with a supporting structure for supporting the static cutter. The supporting structure has a wall portion along the moving direction of the movable cutter, and a wall portion of the movable cutter is supported by the wall portion of the supporting structure. Although this arrangement can also strengthen the strength of the static cutter to a certain extent, a supporting structure needs to be added, which is equivalent to increasing the thickness of the whole static cutter tooth. Therefore, this design cannot be used to cut relatively short hair, in other words, the cutting effect is not ideal when relatively short hair is cut.

Due to the high accuracy required by a hair cutter during cutting, the requirements for the fitting degree of each component in the blade assembly of the hair cutter are also very high. Even if the required accuracy is a few tenths of a decimillimeter worse, the hair may not be cut or the hair may be pulled or the cutter may jump. For each additional component, the cost of mold opening and the difficulty of the manufacturing process increase several times. Therefore, it can be seen from the above description of the prior art that the existing blade assembly of the hair cutter cannot simultaneously solve the problems among the strength, cutting effect and manufacturing process of the hair cutter.

### SUMMARY

In view of this, a static cutter of a hair cutter and a hair cutter are provided.

In order to achieve the above object, the following technical solutions are provided according to the present application.

A static cutter of a hair cutter, cooperating with a movable cutter to cut hair in a moving direction of the movable cutter, has at least one static cutter cutting portion, the at least one static cutter cutting portion forms static cutter teeth, and a cutting groove is formed between any two adjacent static cutter teeth, the static cutter has a first surface which faces a skin and a second surface which is opposite to the first surface, and the static cutter has a local recess area, the local recess area is formed in the first surface or the second surface, and the local recess area at least partially overlaps with an area where the at least static cutter cutting portion is located.

Specifically, the at least one static cutter cutting portion extends along the moving direction of the movable cutter, and the local recess area covers the area where the at least static cutter cutting portion is located.

Specifically, the static cutter includes a static blade body, the static blade body includes one flat surface portion and two inclined surface portions extending from two sides of the flat surface portion, the at least one static cutter cutting portion is formed in at least one of the flat surface portion or the inclined surface portions, or connections between the flat surface portion and the corresponding inclined surface portions, and the local recess area is formed in at least one of the flat surface portion and the inclined surface portions.

Specifically, the static cutter includes a static blade body, the static blade body includes one flat surface portion and two inclined surface portions extending from two sides of the flat surface portion, an arc surface portion is formed between the flat surface portion and the corresponding inclined surface portion, the at least one static cutter cutting portion is formed in at least one of the flat surface portion, the inclined surfaces or the arc surface portions, or connections between the arc surface portions with the flat surface portion and between the arc surface portions and the corresponding inclined surface portions, and the local recess area is formed in at least one of the flat surface portion, the inclined surface portions and the arc surface portions.

Specifically, the static cutter includes a static blade body, the static blade body includes a first flat surface portion, two second flat surface portions extending from two sides of the first flat surface portion, and two curved surface portions extending from the two second flat surface portions, an arc surface portion is formed between the first flat surface portion and the corresponding second flat surface portion, the at least static cutter cutting portion is arranged on the first flat surface portion, the second flat surface portion and the arc surface portion, and the local recess area is formed in at least one of the first flat surface portion, the second flat surface portion or the arc surface portion.

Specifically, the static cutter includes two connecting walls which are arranged opposite to each other, and the two connecting walls are provided with positioning structures for positioning the static cutter.

Specifically, the static cutter further includes a static cutter fixed seat, the static cutter fixed seat is provided with auxiliary positioning structures which cooperate with the positioning structures, and the static cutter is positioned between the positioning structures and the auxiliary positioning structures by means of a pin or a thin shaft.

Specifically, the static cutter fixed seat includes two static cutter retaining walls which are opposite, the static cutter has two end portions in the moving direction of the movable cutter, and the two static cutter retaining walls are in contact and arranged outside the two end portions.

Specifically, the static cutter further includes a static cutter fixed seat, the static cutter fixed seat has two supporting walls, an insertion groove is defined by the static cutter, the static cutter forms notches of the insertion groove respectively at two ends along the moving direction of the movable cutter, the static cutter fixed seat is inserted into the static cutter through the notch of the insertion groove to cooperate with the static cutter, and the two supporting walls support portions, corresponding to two sides of the insertion groove, of the static cutter.

Specifically, the local recess area is located at the static cutter teeth on two sides of the static cutter.

A hair cutter is further provided according to the present application, which includes the above static cutter and the above movable cutter which cooperates with the static cutter, the movable cutter is provided with a movable cutter toothed portion which cooperates with the at least one static cutter cutting portion, and the movable cutter toothed portion forms movable cutter teeth.

Specifically, the hair cutter further includes a movable cutter seat, the movable cutter is connected to the movable cutter to drive the movable cutter to move back and forth, an elastic member is provided between the movable cutter seat and the static cutter fixed seat, and the elastic member has an elastic force perpendicular to the moving direction of the movable cutter to push the movable cutter toward the static cutter.

Specifically, the hair cutter further includes a movable cutter bracket and an elastic member, the movable cutter bracket is connected to the movable cutter, the elastic member has an elastic force perpendicular to the moving direction of the movable cutter, one end of the elastic member is limited by the static cutter fixed seat, and another end of the elastic member is pressed against the movable cutter.

Specifically, the hair cutter further includes a movable cutter bracket, an elastic member and a fixing member bracket, the movable cutter bracket is connected to the movable cutter, the fixing member bracket is connected to the static cutter fixed seat, the elastic member has an elastic force perpendicular to the moving direction of the movable cutter, one end of the elastic member is limited by the fixing member bracket, and another end of the elastic member is pressed against the movable cutter.

Specifically, the fixing member bracket is provided with a connecting structure which is connected to the static cutter fixed seat, the static cutter fixed seat is provided with an auxiliary connecting structure which cooperates with the connecting structure, and the connecting structure and the auxiliary connecting structure are connected by insertion or snapping.

Specifically, the hair cutter further includes a movable cutter limiting member, the movable cutter limiting member is configured to be relatively fixed to the movable cutter, and the movable cutter limiting member is provided with a guiding structure for guiding and limiting the movement of the movable cutter.

Specifically, the movable cutter limiting member is connected to the elastic member or the static cutter fixed seat.

The present application has the following beneficial effects: the static cutter according to the present application is provided with the local recess area, which can not only meet the functional needs of cutting short hair, but also avoid the bending deformation caused by the insufficient strength of a cutter, avoid the wear of the movable and static cutters caused by micro deformation, and effectively reduce the temperature rise. This form of static cutter does not require the design of a component for strengthening the strength of the movable cutter in the conventional blade assembly, reduces the difficulty of assembly, avoids the man hours spent in the multi-component mold opening design, and accordingly reduces the cost of raw materials.

### BRIEF DESCRIPTION OF THE DRAWINGS

For more clearly illustrating the technical solutions of embodiments of the present application or in the conventional technology, drawings referred to for describing the embodiments or the conventional technology will be briefly described hereinafter. Apparently, the drawings in the following description are only several examples of the present application, and for those skilled in the art, other drawings may be obtained based on these drawings without any creative efforts.

FIG. 1 is an exploded view of a hair cutter according to an embodiment of the present application;

FIG. 2 is an exploded view of the hair cutter shown in FIG. 1 viewed from another perspective;

FIG. 3 is an exploded view of the hair cutter according to another embodiment of the present application;

FIG. 4 is an exploded view of the hair cutter shown in FIG. 2 viewed from another perspective;

FIG. 5 is an exploded view of the hair cutter according to another embodiment of the present application;

FIG. 6 is an exploded view of the hair cutter according to another embodiment of the present application;

FIG. 7 is an exploded view of the hair cutter according to another embodiment of the present application;

FIG. 8 is an exploded view of the hair cutter according to another embodiment of the present application;

FIG. 9 is an exploded view of the hair cutter according to another embodiment of the present application;

FIG. 10 is an exploded view of the hair cutter according to another embodiment of the present application;

FIG. 11 is an exploded view of the hair cutter according to another embodiment of the present application, which is a schematic view similar to the embodiment shown in FIG. 6; and

FIG. 12 is an enlarged view of A portion in FIG. 11.

Reference numbers in the drawings are listed as follows:

| | |
|---|---|
| 1, static cutter; | 2, movable cutter; |
| 3, static cutter cutting portion; | 4, static cutter tooth; |
| 5, cutting groove; | 6, movable cutter toothed portion; |
| 7, movable cutter tooth; | 8, first surface; |
| 9, second surface; | 10, local recess area; |
| 11, static blade body; | 12, flat surface portion; |
| 13, inclined surface portion; | 14, arc surface portion; |
| 15, first flat surface portion; | 16, second flat surface portion; |
| 17, curved surface portion; | 18, static cutter fixed seat; |
| 19, connecting wall; | 20, positioning structure; |
| 21, auxiliary positioning structure; | 22, matching groove; |
| 23, static cutter retaining wall; | 24, seat body; |
| 25, end portion; | 26, insertion groove; |
| 27, notch; | 28, supporting wall; |
| 29, bottom surface; | 30, side surface; |
| 31, movable cutter seat; | 32, elastic member; |
| 33, slotted hole; | 34, supporting portion; |
| 35, elastic pre-pressing portion; | 36, arc surface section; |
| 37, movable cutter bracket; | 38, fixing member bracket; |
| 39, connecting structure; | 40, auxiliary connecting structure; |
| 41, bracket wall portion; | 42, groove; |
| 43, movable cutter limiting member; | 44, guiding structure; |
| 45, hair discharge port. | |

### DETAILED DESCRIPTION

Technical solutions in the embodiments of the present application are clearly and completely described hereinafter in conjunction with the drawings in the embodiments of the present application. Apparently, the embodiments described in the following are only some embodiments of the present application, rather than all embodiments. Based on the embodiments in the present application, all of other embodiments, made by the person skilled in the art without any creative efforts, fall into the scope of protection of the present application.

A static cutter of a hair cutter and a hair cutter using the static cutter are provided according to the present application, so as to simultaneously solve the problems among the strength, cutting effect and manufacturing process of the hair cutter.

The present application will be further described below with reference to the accompanying drawings.

The following technical solutions are provided according to the present application.

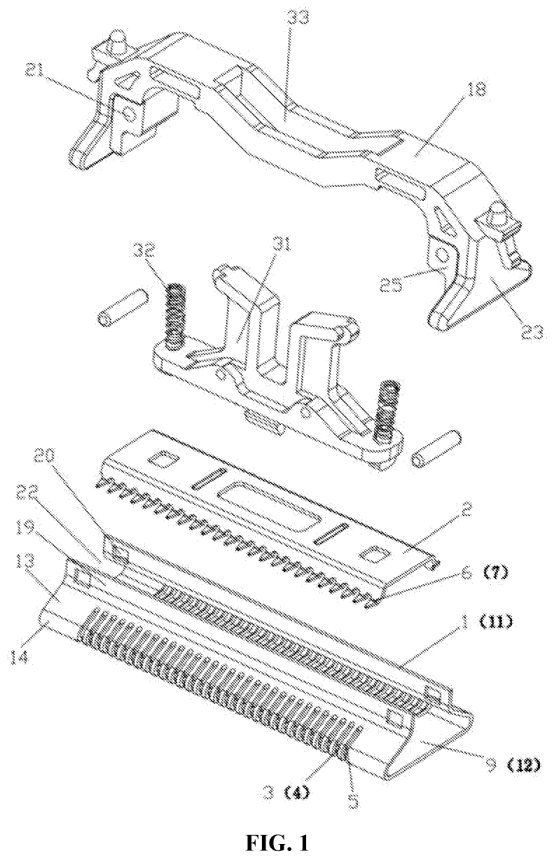

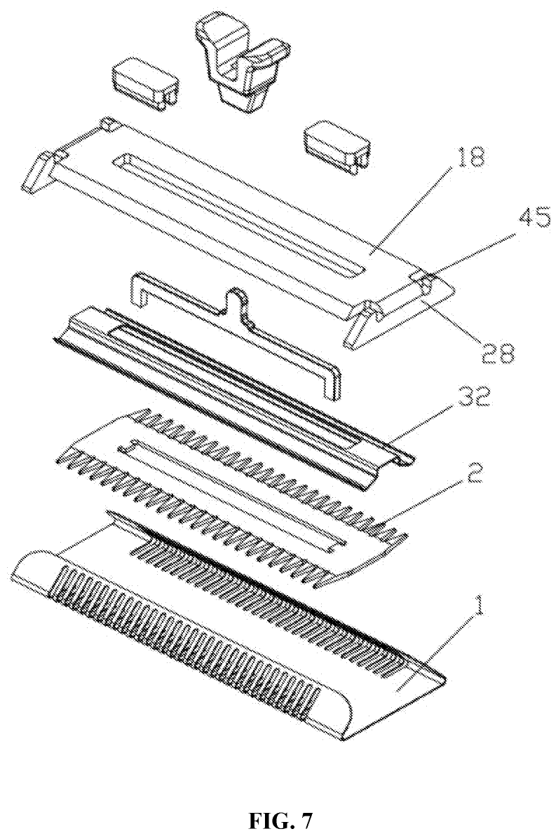

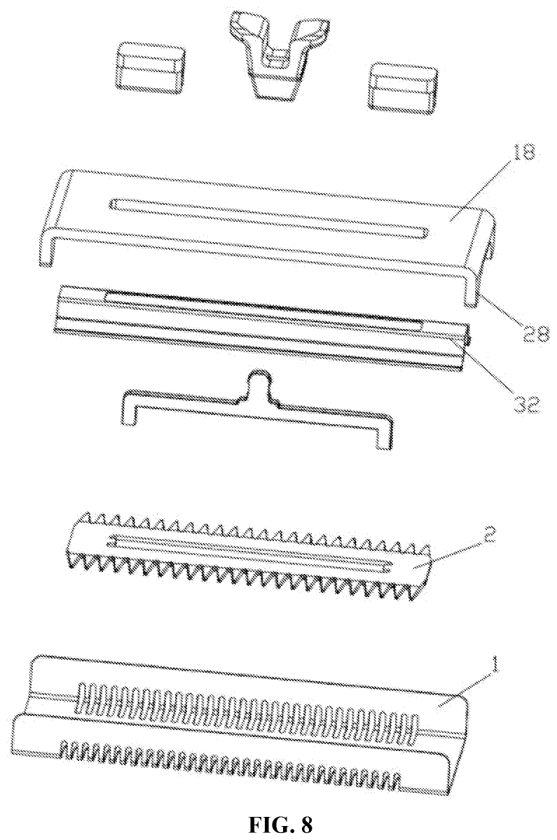

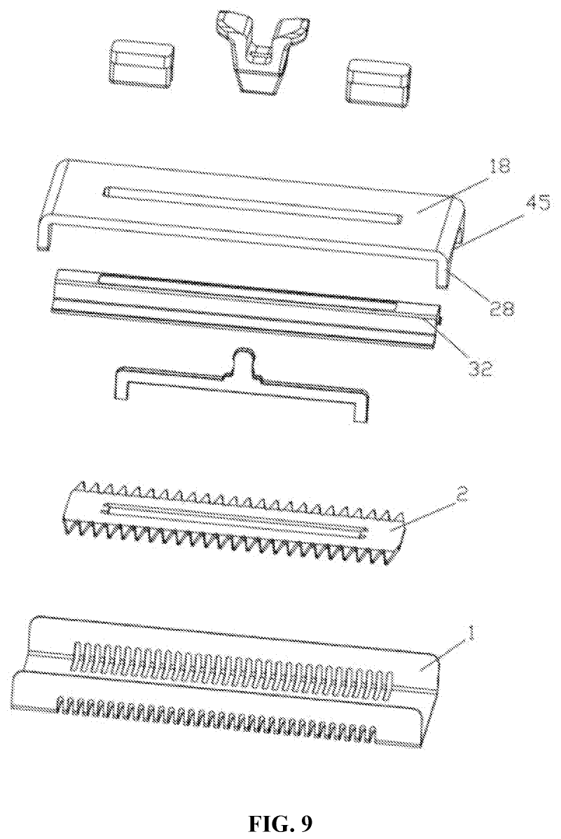

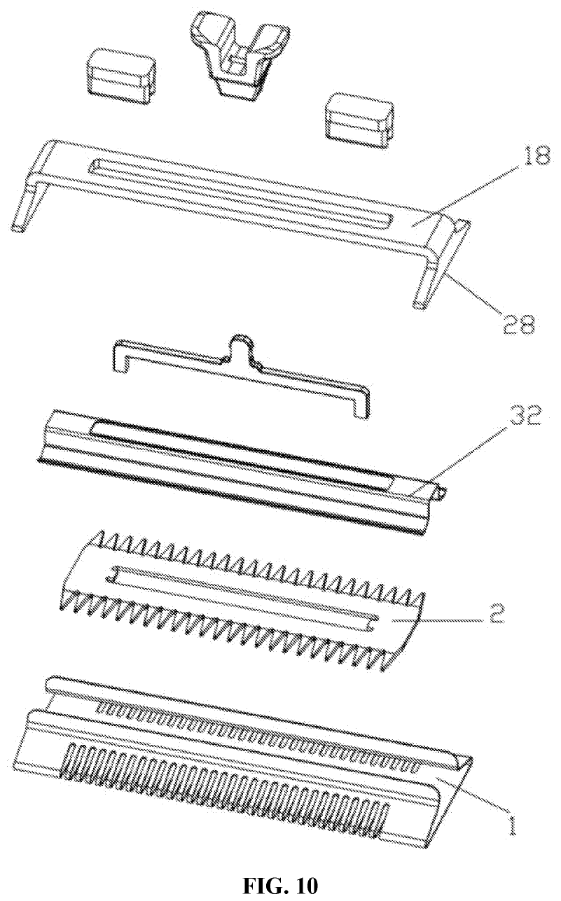

As shown in FIGS. 1 to 12, a static cutter of a hair cutter and a hair cutter having the static cutter are provided. The hair cutter includes a static cutter 1 and a movable cutter 2 for cooperating with the static cutter 1. The static cutter 1 is configured to cooperate with a movable cutter, and the static cutter 1 and the movable cutter 2 can move relatively, generally to cut hair in a moving direction of the movable cutter 2. The static cutter 1 includes at least one static cutter cutting portion 3, the at least one static cutter cutting portion 3 forms static cutter teeth 4, a cutting groove 5 is formed between any two adjacent static cutter teeth 4, the movable cutter 2 is provided with a movable cutter toothed portion 6, and the movable cutter toothed portion 6 has movable cutter teeth 7. The static cutter 1 includes a first surface 8 which faces a skin and a second surface 9 which is opposite to the first surface 8, the static cutter 1 includes a local recess area 10, and the local recess area 10 is formed in the first surface 8 or the second surface 9. The first surface 8 of the hair cutter is in contact with the skin when the hair cutter is in operation. The local recess area 10 at least partially overlaps with an area where the at least one static cutter cutting portion 3 is located.

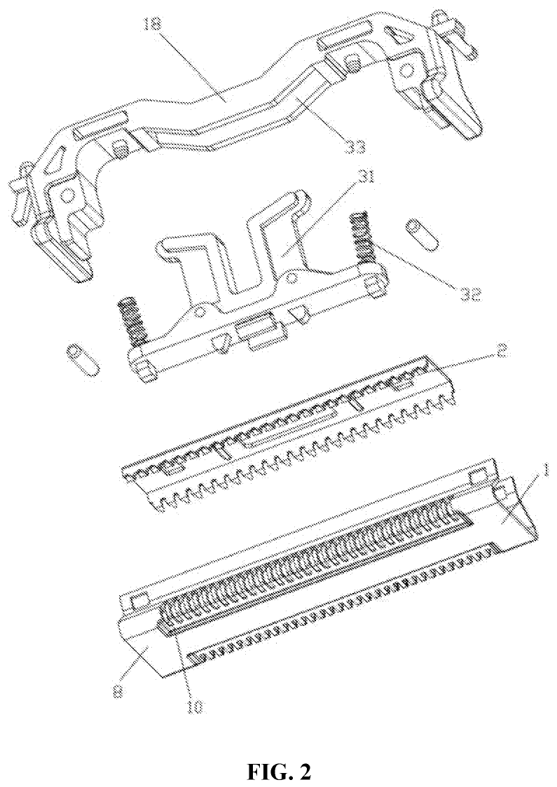

FIG. 1 and FIG. 2 are taken as an example: the local recess area 10 is formed in the first surface 8. Specifically, the static cutter 1 includes a static blade body 11, the static blade body 11 includes one flat surface portion 12 and two inclined surface portions 13 extending from two sides of the flat surface portion 12, and an arc surface portion 14 is formed between the flat surface portion 12 and the corresponding inclined surface portion 13. Preferably, the two inclined surface portions 13 are symmetrically arranged about a centerline of the flat surface portion. The static cutter 1 is provided with two static cutter cutting portion 3, and each static cutter cutting portion 3 is formed at one of connections between the arc surface portions 14 and the flat surface portion 12 and between the arc surface portions 14 and the corresponding inclined surface portions 13. The two static cutter cutting portions 3 are arranged parallel to each other, and both extend along the moving direction of the movable cutter. The local recess area 10 extends along the static cutter cutting portion 3. Preferably, the static cutter 1 forms a static blade body 11 with the flat surface portion 12, the inclined surface portions 13 and the arc surfaces portions 14 by bending in the form of a prefabricated sheet, and the static blade body 11 may be made of metal or other alloy materials with good welding performance. The local recess area 10 at least partially overlaps with the area where the at least one static cutter cutting portion 3 is located. Specifically, as shown in FIG. 1 and FIG. 2, the local recess area 10 is the flat surface portion 12 formed in the static cutter cutting portion 3, and covers the flat surface portion 12 of the static cutter cutting portion 3 in a length direction of the static cutter cutting portion 3. As shown in figures, the flat surface portions 12 of the two static cutter cutting portions 3 are correspondingly provided with the local recess area 10. In practice, the local recess area 10 can be provided only in one flat surface portion 12, and the length of the local recess area 10 is not necessary to cover the length of the static cutter cutting portion 3, that is, the local recess area 10 of the static cutter cutting portion 3 can be a section provided in the length direction of the static cutter cutting portion 3.

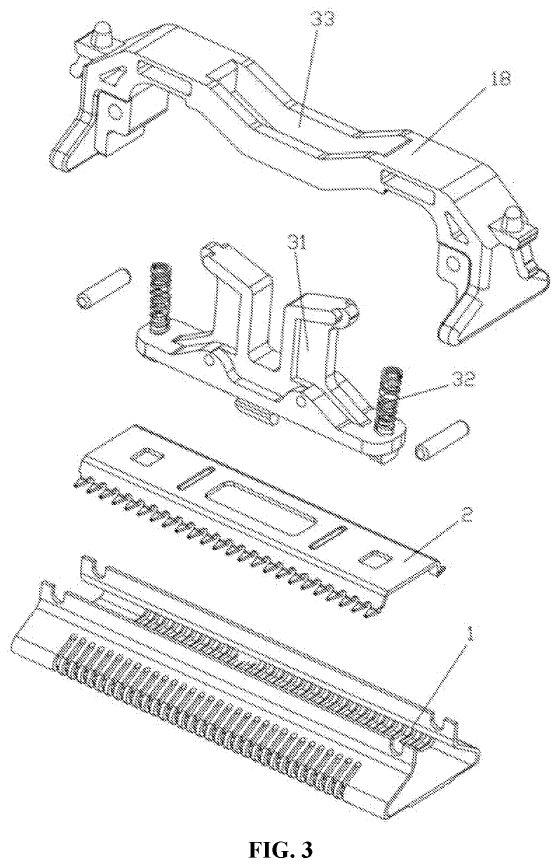

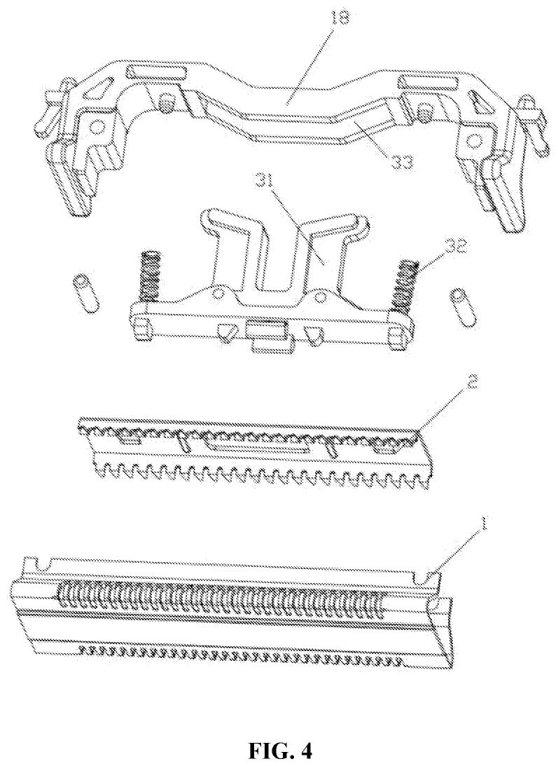

It can be understood that in order to maintain the strength of the static cutter 1 and meet the requirement of having thin enough teeth to cut shorter hairs, in the specific implementation, the static cutter cutting portion 3 may be formed in one of the flat surface portion 12, the inclined surface portions 13 or the arc surface portions 14 according to the actual needs, and correspondingly, at least one of the flat surface portion 12, the inclined surface portion 13 or the arc surface portion 14 forms the local concave area 10. As shown in FIG. 3 and FIG. 4, FIG. 3 and FIG. 4 shows another embodiment of the present application. Specifically, the arrangement form of the static blade body 11 is the same with that in FIG. 1. Similarly, the static cutter cutting portion 3 extends along the moving direction of the movable cutter 2, and the difference is that: the local recess area 10 covers all area where the two static cutter cutting portions 3 are located. After this arrangement, a rectangular opposite protrusion is formed in the center of the cutter body. The local recess area may be located at the static cutter teeth 4 on two sides of the static cutter 1. The static cutter 1 according to the present application is provided with the local recess area 10, which can not only meet the functional needs of cutting short hair, but also avoid the bending deformation caused by insufficient cutter strength, avoid the wear between the movable and static cutters caused by micro deformation, and effectively reduce the temperature rise. This form of static cutter 1 does not require the design of the component for strengthening the strength of the movable cutter in the conventional blade assembly, reduces the difficulty of assembly, avoids the man hours spent in the multi-component mold opening design, and correspondingly reduces the cost of raw materials.

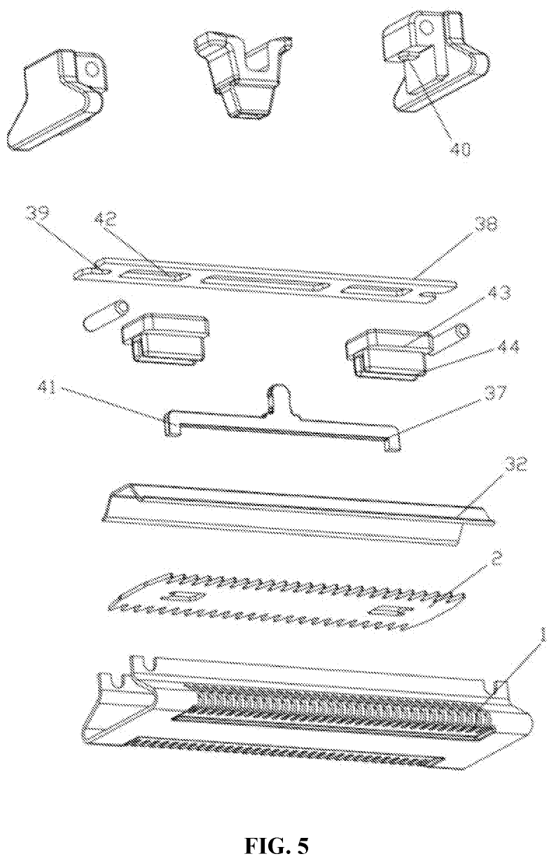

As shown in FIG. 5, FIG. 5 shows another embodiment of the present application. Specifically, the arrangement form of the static blade body 11 is the same with that in FIG. 1 and FIG. 3. Similarly, the static cutter cutting portion 3 extends along the moving direction of the movable cutter 2, the difference is that: the static blade body 11 is provided with three static cutter cutting portions 3, that is, a static cutter cutting portion 3 independently formed in the flat surface portion is added in FIG. 5 compared with FIG. 1 and FIG. 2, correspondingly, the local recess area 10 covers the static cutter cutting portion 3 of the flat surface portion 12, certainly the local recess area 10 of the flat surface portion 12 may only cover part of the static cutter cutting portion 3 of the flat surface portion 12. The arrangement of the three static cutter cutting portions 3 and the local concave area 10 corresponding to each static cutter cutting portion 3 is equivalent to forming a thickness strengthening area between two static cutter cutting portions 3. This arrangement can also strengthen the strength of the static cutter 1. The thickness strengthening area can be two parallel strengthening portions, or can form square, rectangular and other frame forms according to the different position and shape of the local recess area 10, which is not listed herein.

Certainly, the static blade body 11 may be configured to include one flat surface portion 12 and two inclined surface portions 13 extending from two sides of the flat surface portion 12, the at least one static cutter cutting portion 3 is formed in at least one of the flat surface portion 12 or the inclined surface portions 13, or connections between the flat surface portion 12 and the corresponding inclined surface portions 13. Similarly, the local recess area 10 is formed in at least one of the flat surface portion 12 and the inclined surface portions 13.

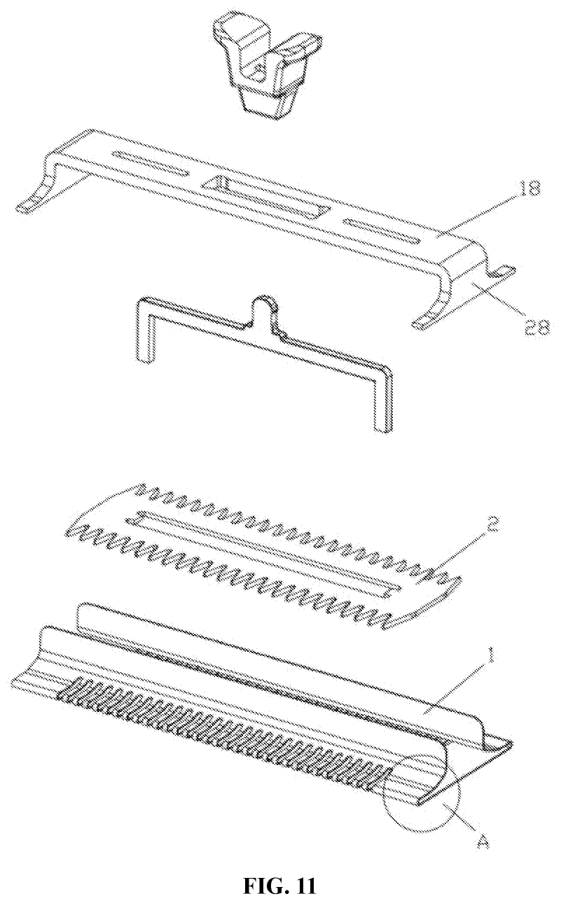

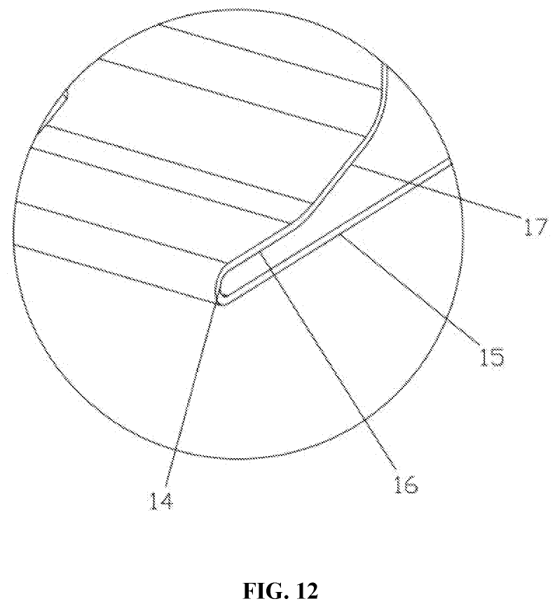

Specifically, as shown in FIG. 11 and FIG. 12, the static blade body 11 may be configured to include a first flat surface portion 15, two second flat surface portions 16 extending from two sides of the first flat surface portion 15, and two curved surface portions 17 extending from the two second flat surface portions 16, an arc surface portion 14 is formed between the first flat surface portion 15 and the corresponding second flat surface portion 16, the at least one static cutter cutting portion 3 is arranged on at least one of the first flat surface portion 15, the second flat surface portions 16 and the arc surface portions 14, or the at least one static cutter cutting portion 3 is arranged on at least one of the first flat surface portion 15, the second flat surface portions 16, the arc surface portions 14 and part of curved surface portions 17, and the local recess area 10 is formed in at least one of the first flat surface portion 15, the second flat surface portions 16, the arc surface portions 14 or the curved surface portions 17. The static blade body 11 is arranged such that the curved surface portion 17 enables the static blade body 11 to have a movable pre-pressing elastic force during assembly. The pre-pressing elastic force has a component force perpendicular to the moving direction of the movable cutter 2, which can effectively prevent the micro deformation of the static blade body 11. Due to the high accuracy required by a hair cutter during cutting, the requirements for the fitting degree of each component are also very high. Even if the required accuracy is a few tenths of a decimillimeter worse, the hair may not be cut and the hair may be pulled or the cutter may jump.

Furthermore, referring to FIGS. 1 to 6, specifically, the static cutter 1 further includes a static cutter fixed seat 18, the static blade body 11 further includes two connecting walls 19 which are arranged opposite to each other. Specifically, the two connecting walls 19 are respectively formed by corresponding inclined surface portions 13 or curved surface portions 17 extending toward the static cutter fixed seat 18, the two connecting walls are provided with positioning structures 20, and the static cutter fixed seat 18 may be in an integral form shown in FIG. 1, or in a split state shown in FIG. 5. The static cutter fixed seat 5 is provided with auxiliary positioning structures 21 which cooperate with the positioning structures 20, and the static cutter 1 is positioned between the positioning structures 20 and the auxiliary positioning structures 21 by means of a buckle, a rivet, a pin or a thin shaft.

As shown in FIG. 1, the specific structure and the connection method between the static cutter 1 and the static cutter fixed seat 18 are described in detail: in this figure, the two connecting walls 19 are parallel to each other, and a matching groove 22 which is matched with the static cutter fixed seat 18 is formed between the connecting walls 19. The positioning structures 20 are grooves formed at two ends of the two connecting walls 19, and the grooves can be closed grooves as shown in FIG. 1, or can be grooves with an opening which is defined by an end of the connecting wall 19 as shown in FIG. 3. It should be noted that the terms “closed” and “open” are relatively descriptive words, which should not be used to infer or limit the form of the groove. Preferably, in the in the disclosed embodiment, the auxiliary positioning structures 21 are matching grooves 22 or matching holes formed in the static cutter fixed seat 18, which corresponds to positions of the grooves defined in the connecting walls 19, and the two are connected by a pin (a shaft). The “pin” refers to that in the specific implementation, the shaft connecting the two is very thin, which is limited by the limited mounting space in the static cutter and the static cutter fixed seat 18. After such arrangement, the matching groove 22 between the two connecting walls 19 does not need to be temporarily expanded outward to adapted to a protruding structure arranged on the static cutter fixed seat 18 when the static cutter 1 and the static cutter fixed seat 18 are assembled, the static blade body is extremely thin, generally only a few tenths of decimillimeter. This kind of outward expansion of the connecting wall 19 caused by the temporary external force during mounting may generally cause the micro deformation of the static blade body. Due to the high accuracy of the hair cutter during cutting, the requirements for the fit degree of each component in the blade assembly of the hair cutter are also very high. Even if the required precision fit is a few tenths of a decimillimeter worse, the hair may not be cut or the hair may be pulled or the cutter may jump, and this micro deformation is bound to affect the mutual fit of the whole blade assembly, affect the cutting effect, and affect the cutting comfort caused by the hair pulling, and the embodiment disclosed by the present application can effectively avoid the above defects.

Specifically, the static cutter fixed seat 18 includes two static cutter retaining walls 23 which are opposite. It is not difficult to understand that when the static cutter fixed seat 18 is in the overall form described in FIGS. 1 to 4, the static cutter fixed seat 18 has a seat body 24 for connecting the two static cutter retaining walls 23. The static cutter 1 includes two end portions 25 in the moving direction of the movable cutter 2, and the static cutter retaining walls 25 are arranged corresponding to the two end portions 25 of the static cutter 1. As shown in FIG. 1 to FIG. 5, the two static cutter retaining walls 23 are in contact and arranged outside the two end portions 25. The “Contact” means that the static cutter retaining walls 23 are in contact with two ends of the static cutter 1 to form protection for the static cutter 1.

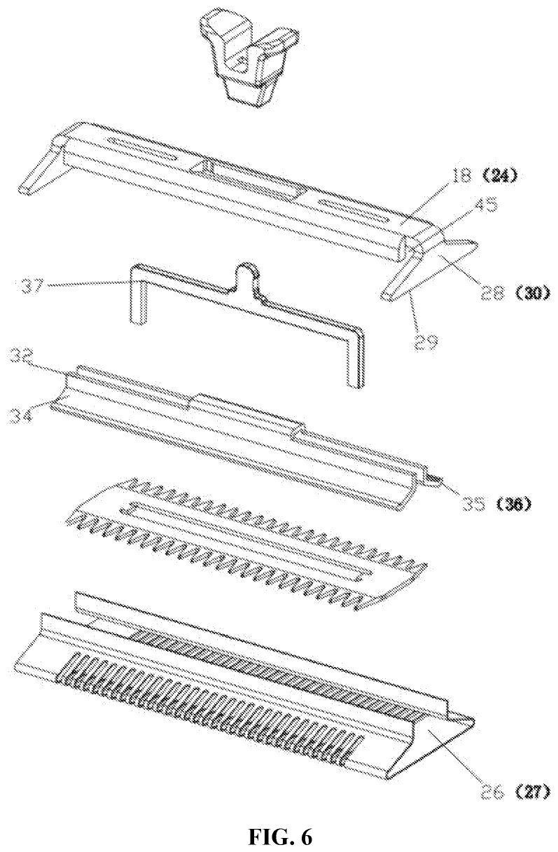

The static cutter fixed seat 18 may have a structure shown in FIGS. 6 to 10. Specifically, the static cutter fixed seat 18 includes two supporting walls 28. Similarly, the static cutter fixed seat 18 may be in an integral form or a split state. The static cutter fixed seat 18 shown in FIGS. 6 to 10 is in the integral form, and the static cutter fixed seat 18 includes a seat body 24 for connecting the two supporting walls 28. An insertion groove 26 is defined by the static blade body 11, the static blade body 11 forms notches 27 of the insertion groove 26 respectively at two ends along the moving direction of the movable cutter 1, the static cutter fixed seat 18 is inserted into the static cutter 1 through the notch 27 of the insertion groove 26 to cooperate with the static cutter 1, and the two supporting walls 28 support portions, corresponding to two sides of the insertion groove 26, of the static cutter 1, that is, the two supporting walls 28 supports portions, corresponding to the notches 27 of the insertion groove 26, of the static cutter 1. More specifically, at least part of the supporting wall 05 supports the first flat surface portion 15. The first flat surface portion 15 is the same with the flat surface portion in FIGS. 1 to 5. Both the first flat surface portion 15 and the flat surface portion 12 are flat surfaces arranged opposite to the static cutter fixed seat 18. The static cutter fixed seat 18 is inserted into the insertion groove 26 through the notch 26 of the insertion groove 26 from one end of the supporting walls 28 when the static blade body 11 is assembled with the static cutter fixed seat 18, that is, the supporting walls 28 face the notches during the assembly process. As shown in a direction shown in FIG. 6, a cross section of the supporting wall 28 along the moving direction of the movable cutter 1 is the same with a cross section of the notch, and a bottom surface 29 and two side surfaces 30 of the supporting wall 28 form a support for the static blade body 11 at the notches after the assembly is completed. That is, the bottom surface 29 of the supporting wall 28 supports the static blade body 11, and the two side surfaces 30 support at least the inclined portions 13 of the static blade body 11 according to the shape of the static blade body 11. In the process of assembling the static blade body 11 and the static cutter fixed seat 18, the flat surface portion 12 is easy to produce bending deformation as shown in the figure under the action of the inclined surface portions 13 of the static blade body 11. In the process of assembling the supporting walls 28 with the static blade body 11, the supporting walls 28 are in contact with the static cutter, and the supporting wall 28 forms an arch or an arch-like structure with the seat body 24 of the static cutter fixed seat 18, the static cutter fixed seat 18 is easy to form bending deformation along the arch structure under the restriction of the structure. The deformation formed under the action of this deformation force intersects with the deformation formed by the static blade body 11, that is, the arrangement form of the static cutter fixed seat 18 can suppress and offset the micro deformation of the static blade body 11, and similarly, the arrangement form of the static blade body 11 can also suppress and offset the micro deformation easily generated by the static cutter fixed seat 18. Therefore, with the arrangement form of the static cutter 1, the overall stability of the static cutter 1 is high, which is more in line with the high-precision coordination requirements between various components required by the hair cutter in the operation, avoids the wear between the movable and static cutters caused by the micro deformation, and effectively reduces the temperature rise. In addition, the shape of the static cutter 1 is maintained, which ensures the cut force formed between the static cutter teeth 4 and the movable cutter teeth 6 during cutting, and avoids the occurrence of hair pulling, which further improves the comfort of use. No other supporting member is provided between the static cutter teeth 4 and the movable cutter teeth 6, which is equivalent to thinning the thickness of the static cutter teeth 4 as a whole, and is more suitable for cutting shorter hair compared with the structural design with supporting member between the static cutter teeth 4 and the movable cutter teeth 6 in the conventional technology.

Specifically, the hair cutter further includes a movable seat 31 which is connected to the movable cutter 2 to drive the movable cutter 2 to move back and forth. The movable cutter 2 and the movable cutter seat 31 are arranged to be relatively fixed, and the movable cutter 2 and the movable cutter seat 31 can be fixed by means of snapping, bonding or welding. Generally, the movable cutter seat 31 is connected to a power source, and the power source has the force to drive the movable cutter seat 31 to move back and forth.

Specifically, referring to FIGS. 6 to 10, the supporting walls 28 of the static cutter fixed seat 18 both perpendicular to the moving direction of the movable cutter 2. In actual implementation, the supporting walls 28 may also be inclined with respect to the moving direction of the movable cutter 2. In addition to the shape shown in FIG. 6, the supporting walls 28 can be further arranged in the form of a rectangle, a triangle, an arch, a “concave” shape or a “convex” shape. The supporting walls 28 may only be configured such that only its bottom surface 29 supports the flat surface portion 12 at the notches, and it is not necessary to design two side surfaces 30 to support the static blade body 11 at the notches. That is, the cross-sectional shape of the supporting wall 28 is not necessarily limited to be the same with or matched with that of the notches. When the supporting wall 28 is arranged in the form of a rectangle, a triangle, an arch, “concave” or “convex”, a row of hair discharge ports 45 can be further formed at the supporting walls 28 and the notches, so that the hairs entering the insertion groove 26 can be easily cleaned out after this arrangement.

As shown in FIG. 1, an elastic member 32 is provided between the movable cutter seat 31 and the static cutter fixed seat 18, the elastic member 32 is a spring mounted between the movable cutter seat 31 and the static cutter fixed seat 18, and the elastic member 32 has an elastic force perpendicular to the moving direction of the movable cutter to push the movable cutter 2 toward the static cutter 1. In this arrangement, the static cutter teeth 4 and the movable cutter teeth 6 are in contact with each other, which can cut shorter hairs, and has a higher the overall stability of the blade assembly. Specifically, a slotted hole 33 is defined in the static cutter fixed seat 18, and an upper portion of the movable cutter seat 31 is inserted through the slotted hole 33 and is connected to the power source. The static cutter fixed seat 18 in FIG. 1 has a recess area facing the static blade body 1, so that such design reduces the height of the static cutter fixed seat 18, thereby reducing the overall assembly space of the hair cutter, improving the structural stability of the hair cutter, and miniaturizing the overall volume design more compact, which is convenient for portability and storage.

Specifically, as shown in FIG. 6, the hair cutter may be configured to include a movable cutter bracket 37 and an elastic member 32, the movable cutter bracket 37 is connected to the movable cutter 2, the elastic member 32 has an elastic force perpendicular to the moving direction of the movable cutter 2, the difference from FIG. 1 is that: one end of the elastic member 32 is limited by the static cutter fixed seat 18, and another end of the elastic member 32 is pressed against the movable cutter 2. Specifically, the elastic member 32 includes a supporting portion 34 and two elastic pre-pressing portions 35 extending from two sides of the supporting portion 34 respectively, and each elastic pre-pressing portion 35 has an arc surface section 36 that is in pre-pressing contact with the movable cutter 2. The supporting portion 34 is connected to the static cutter fixed seat 18. Specifically, a slotted hole 33 is defined in the static cutter fixed seat 18, and the supporting portion 34 is inserted into the slotted hole 33 and is engaged with the slotted hole 33, thereby forming a relatively fixed connection between the elastic member 32 and the static cutter fixed seat 18.

Specifically, as shown in FIG. 5, the hair cutter is arranged to include a movable cutter bracket 37, an elastic member 32 and a fixing member bracket 38, the movable cutter bracket 37 is connected to the movable cutter 2, and the fixing member bracket 38 is connected to the static cutter fixed seat 18. The elastic member 32 has an elastic force perpendicular to the moving direction of the movable cutter 2, one end of the elastic member 32 is limited by the fixing member bracket 38, and another end of the elastic member 32 is pressed against the movable cutter 2. Specifically, the elastic member 32 is the same with the elastic member 32 in FIG. 6. The fixing member bracket 38 is provided with a connecting structure 39 which is connected to the static cutter fixed seat 18, the static cutter fixed seat is provided with an auxiliary connecting structure 40 which cooperates with the connecting structure 39. Specifically, the connecting structures 39 are connecting grooves arranged at two ends of the fixing member bracket 38, the auxiliary connecting structure 40 are protrusion arranged on the static cutter fixed seat 18, and the two protrusions are inserted into the corresponding connecting grooves to relatively fix the fixing member bracket 38 with the static cutter fixed seat 18. The connecting structures 39 and the auxiliary connecting structures 40 are connected by means of insertion or snapping. Specific similar connection methods that can be thought of by those skilled in the art will not be exemplified here. The movable cutter bracket 37 includes two bracket wall portions 41 which are connected to the movable cutter 2, and the fixing member bracket 38 and the elastic member 32 are provided with grooves 42 for the bracket wall portions 41 to pass through. The grooves 42 are arranged to extend along the moving direction of the movable cutter 2, and the displacement of the movable cutter bracket 37 can be further limited by the grooves 42 after this arrangement.

Specifically, the hair cutter further includes a movable cutter limiting member 43, the movable cutter limiting member 43 is configured to be relatively fixed to the movable cutter 2, and the movable cutter limiting member 43 is arranged to be connected to the elastic member 32 or the static cutter fixed seat 18. The movable cutter limiting member 43 is configured to be relatively fixed to the movable cutter 2. Specifically, the movable cutter limiting member 43 may be connected to the elastic member 32 or the static cutter fixed seat 18 by fixed connection such as welding (spot welding or touch welding), secondary molding fixation, or removable connection such as a buckle. The movable cutter limiting member 43 is provided with a guiding structure 44 for guiding and limiting the movement of the movable cutter 2.

According to the above description of the disclosed embodiments, those skilled in the art may implement or practice the present application. Many modifications to these embodiments are apparent for those skilled in the art. The general principles defined herein may be applied to other embodiments without departing from the spirit or scope of the present application. Therefore, the present application should not be limited to the embodiments disclosed herein, but has the widest scope in accordance to the principle and the novel features disclosed herein.

1. A static cutter of a hair cutter, cooperating with a movable cutter to cut hair in a moving direction of the movable cutter, wherein the static cutter has at least one static cutter cutting portion, the at least one static cutter cutting portion has static cutter teeth, and a cutting groove is formed between any two adjacent static cutter teeth, the static cutter has a first surface which faces a skin and a second surface which is opposite to the first surface, and the static cutter has a local recess area, the local recess area is formed in the first surface or the second surface, and the local recess area at least partially overlaps with an area where the at least one static cutter cutting portion is located.

2. The static cutter of the hair cutter according to claim 1, wherein the at least one static cutter cutting portion extends along the moving direction of the movable cutter, and the local recess area covers the area where the at least one static cutter cutting portion is located.

3. The static cutter of the hair cutter according to claim 1, wherein the static cutter comprises one static blade body, the static blade body comprises one flat surface portion and two inclined surface portions extending from two sides of the flat surface portion, the at least one static cutter cutting portion is formed in at least one of the flat surface portion or the inclined surface portions, or connections between the flat surface portion and the corresponding inclined surface portions, and the local recess area is formed in at least one of the flat surface portion and the inclined surface portions.

4. The static cutter of the hair cutter according to claim 1, wherein the static cutter comprises a static blade body, the static blade body comprises one flat surface portion and two inclined surface portions extending from two sides of the flat surface portion, an arc surface portion is formed between the flat surface portion and the corresponding inclined surface portion, the at least one static cutter cutting portion is formed in at least one of the flat surface portion, the inclined surfaces or the arc surface portions, or connections between the arc surface portions and the flat surface portion and between the arc surface portions and the corresponding inclined surface portions, and the local recess area is formed in at least one of the flat surface portion, the inclined surface portion and the arc surface portion.

5. The static cutter of the hair cutter according to claim 1, wherein the static cutter comprises a static blade body, the static blade body comprises a first flat surface portion, two second flat surface portions extending from two sides of the first flat surface portion, and two curved surface portions extending from the two second flat surface portions, an arc surface portion is formed between the first flat surface portion and the corresponding second flat surface portion, the at least static cutter cutting portion is arranged on the first flat surface portion, the second flat surface portion and the arc surface portion, and the local recess area is formed in at least one of the first flat surface portion, the second flat surface portion or the arc surface portion.

6. The static cutter of the hair cutter according to claim 1, wherein the static cutter comprises two connecting walls which are opposite to each other, and the two connecting walls are provided with positioning structures for positioning the static cutter.

7. The static cutter of the hair cutter according to claim 6, wherein the static cutter further comprises a static cutter fixed seat, the static cutter fixed seat is provided with auxiliary positioning structures for cooperating with the positioning structures, and the static cutter is positioned between the positioning structures and the auxiliary positioning structures by means of a pin or a thin shaft.

8. The static cutter of the hair cutter according to claim 7, wherein the static cutter fixed seat comprises two static cutter retaining walls which are opposite, the static cutter has two end portions in the moving direction of the movable cutter, and the two static cutter retaining walls are in contact and arranged outside the two end portions.

9. The static cutter of the hair cutter according to claim 1, wherein the static cutter further comprises a static cutter fixed seat, the static cutter fixed seat has two supporting walls, an insertion groove is defined by the static cutter, the static cutter forms notches of the insertion groove respectively at two ends along the moving direction of the movable cutter, the static cutter fixed seat is inserted into the static cutter through the notch of the insertion groove to cooperate with the static cutter, and the two supporting walls support portions, corresponding to two sides of the insertion groove, of the static cutter.

10. The static cutter of the hair cutter according to claim 1, wherein the local recess area is located at the static cutter teeth on two sides of the static cutter.

11. A hair cutter, comprising a static cutter and a movable cutter for cooperating with the static cutter, wherein
the static cutter cooperates with the movable cutter to cut hair in a moving direction of the movable cutter, the static cutter has at least one static cutter cutting portion, the at least one static cutter cutting portion has static cutter teeth, and a cutting groove is formed between any two adjacent static cutter teeth, the static cutter has a first surface which faces a skin and a second surface which is opposite to the first surface, and the static cutter has a local recess area, the local recess area is formed in the first surface or the second surface, and the local recess area at least partially overlaps with an area where the at least one static cutter cutting portion is located; and
the movable cutter is provided with a movable cutter toothed portion for cooperating with the at least one static cutter cutting portion, and the movable cutter toothed portion forms movable cutter teeth.

12. The hair cutter according to claim 11, wherein the hair cutter further comprises a movable cutter seat, the movable cutter seat is connected to the movable cutter to drive the movable cutter to move back and forth, an elastic member is provided between the movable cutter seat and the static cutter fixed seat, and the elastic member has an elastic force perpendicular to the moving direction of the movable cutter to push the movable cutter toward the static cutter.

13. The hair cutter according to claim 11, wherein the hair cutter further comprises a movable cutter bracket and an elastic member, the movable cutter bracket is connected to the movable cutter, the elastic member has an elastic force perpendicular to the moving direction of the movable cutter, one end of the elastic member is limited by the static cutter fixed seat, and another end of the elastic member is pressed against the movable cutter.

14. The hair cutter according to claim 11, wherein the hair cutter further comprises a movable cutter bracket, an elastic member and a fixing member bracket, the movable cutter bracket is connected to the movable cutter, the fixing member bracket is connected to the static cutter fixed seat, the elastic member has an elastic force perpendicular to the moving direction of the movable cutter, one end of the elastic member is limited by the fixing member bracket, and another end of the elastic member is pressed against the movable cutter.

15. The hair cutter according to claim 14, wherein the fixing member bracket is provided with a connecting structure which is connected to the static cutter fixed seat, the static cutter fixed seat is provided with an auxiliary connecting structure for cooperating with the connecting structure, and the connecting structure is connected to the auxiliary connecting structure by insertion or snapping.

16. The hair cutter according to claim 11, wherein the hair cutter further comprises a movable cutter limiting member, the movable cutter limiting member is arranged to be relatively fixed to the movable cutter, and the movable cutter limiting member is provided with a guiding structure for guiding and limiting the movement of the movable cutter.

17. The hair cutter according to claim 16, wherein the movable cutter limiting member is connected to the elastic member or the static cutter fixed seat.
